(19) United States
(12) Patent Application Publication
(10) Pub. No.: US 2015/0030901 A1
(43) Pub. Date: Jan. 29, 2015

(54) BATTERY HEATER SYSTEMS AND METHODS

(71) Applicant: General Electric Company, Schenectady, NY (US)

(72) Inventors: Richard Scott BOURGEOIS, Albany, NY (US); Huibin ZHU, Westford, MA (US)

(73) Assignee: General Electric Company, Schenectady, NY (US)

(21) Appl. No.: 13/951,979

(22) Filed: Jul. 26, 2013

(51) Int. Cl. H01M 10/615; H01M 10/42

(52) U.S. Cl. CPC H01M 10/5006; H01M 10/425
USPC 429/120

(57) ABSTRACT

Systems and methods for supplying power to a battery heater in one or more battery modules. A first DC electrical signal derived from an AC source or a second DC electrical signal derived from a DC bus is used to power a battery heater of one or more battery modules in dependence on a voltage level associated with the first DC electrical signal relative to a voltage level of the second DC electrical signal.

### BACKGROUND

1. Technical Field

Embodiments of the subject matter disclosed herein relate to systems employing battery modules that are heated, and associated heater power supplies and methods of providing power for heating battery modules.

2. Discussion of Art

In various types of battery back-up systems, a sodium-based battery module operates at high temperatures and uses an electric heater system to keep the electro-chemical cells of the battery module within a well regulated temperature range. AC heater circuits use electric power from an AC grid, and DC heater circuits use power drawn from a DC bus. Systems with DC heater circuits can ride through AC grid outages and faults. However, in such systems, start-up issues can exist. Some systems do not include inverters with a pre-charge circuit to ramp up the DC bus from the AC grid energy at start-up. Instead, the inverters depend on a battery pack to charge up the DC bus at start-up. Such systems can become locked out during start-up and require an external battery pack to jump start the DC bus. Some systems use an AC heater circuit to attempt to solve the AC grid outage problem. An inverter is used to convert battery energy back into the AC grid to ride through the AC grid outage. However, depending on the particular applications, the AC grid may be connected to the local grid and the battery module may not be able to support all of the local loads, thus causing the system to trip. Moreover, such an approach does not work in wind or solar renewable applications which typically require the inverters to support reactive power to the grid, and not operate in the voltage mode or the real power mode.

It may be desirable to have a system and method that differs from those systems and methods that are currently available.

### BRIEF DESCRIPTION

Embodiments of the present invention address the limitations discussed above associated with heating battery modules in various types of battery back-up systems.

In one embodiment, a power supply circuit is provided that is a combined AC/DC heater power supply circuit configured to provide a complete and real solution to the heater start-up issue as well as the AC grid outage problem. The power supply circuit includes a first circuit portion operable to convert AC electrical power, provided by an AC source, to a first DC electrical power. The power supply circuit also includes a second circuit portion operable to output a second DC electrical power derived from a DC bus operably connected to at least one DC source. The first circuit portion and the second circuit portion are operably connected and configured to provide either the first DC electrical power or the second DC electrical power to a heater circuit of a battery module in dependence on a voltage level associated with the first circuit portion relative to a voltage level associated with the second circuit portion.

In one embodiment, a system is provided for supplying power to heat a plurality of battery modules. The system includes a plurality of battery modules and a plurality of the power supply circuits described above herein. Each battery module of the plurality of battery modules is associated with one power supply circuit of the plurality of power supply circuits. Each power supply circuit of the plurality of power supply circuits is configured to provide either the first DC electrical power or the second DC electrical power to a heater circuit in an associated battery module in dependence on a voltage level associated with the first circuit portion of the power supply circuit relative to a voltage level associated with the second circuit portion of the power supply circuit.

In one embodiment, a system is provided for supplying power to heat a plurality of battery modules. The system includes a plurality of battery modules and at least one heater power supply circuit as described above herein and configured to provide either the first DC electrical power or the second DC electrical power to a heater circuit of each of the plurality of battery modules in dependence on a voltage level associated with the first circuit portion of the at least one power supply circuit relative to a voltage level associated with the second circuit portion of the at least one power supply circuit.

In one embodiment, a method is provided for powering at least one battery module. The method includes inputting a first DC electrical signal derived from an AC source, inputting a second DC electrical signal derived from a DC source, and powering a heater of at least one battery module with either the first DC electrical signal or the second DC electrical signal in dependence on a DC voltage level of the first DC electrical signal relative to a DC voltage level of the second DC electrical signal.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of a block diagram of an embodiment of a system for providing power to a heater of a battery module;

FIG. 2 is a more detailed illustration of a block diagram of the system of FIG. 1;

FIG. 3 is an electrical schematic illustration of the system of FIG. 1 and FIG. 2;

FIG. 4 is a flowchart of an embodiment of a method to provide power to a heater of at least one battery module;

FIG. 5 is an illustration of a block diagram of a first embodiment of a system providing power to a heater of each of a plurality of battery modules;

FIG. 6 is an illustration of a block diagram of a second embodiment of a system providing power to a heater of each of a plurality of battery modules;

FIG. 7 is an illustration of a block diagram of a third embodiment of a system providing power to a heater of each of a plurality of battery modules;

FIG. 8 is an illustration of a block diagram of a fourth embodiment of a system providing power to a heater of each of a plurality of battery modules;

FIG. 9 is an illustration of a block diagram of a fifth embodiment of a system providing power to a heater of each of a plurality of battery modules;

FIG. 10 is an illustration of a block diagram of a sixth embodiment of a system providing power to a heater of each of a plurality of battery modules;

FIG. 11 is an electrical schematic illustration of an embodiment of a system for providing power to heaters of a plurality of battery modules;

FIG. 12 is an electrical schematic illustration of a first alternate embodiment of a system for providing power to heaters of a plurality of battery modules;

FIG. 13 is an electrical schematic illustration of a second alternate embodiment of a system for providing power to heaters of a plurality of battery modules;

FIG. 14 is an electrical schematic illustration of a third alternate embodiment of a system for providing power to heaters of a plurality of battery modules;

FIG. 15 is an electrical schematic illustration of a fourth alternate embodiment of a system for providing power to heaters of a plurality of battery modules; and

FIG. 16 is an electrical schematic illustration of a fifth alternate embodiment of a system for providing power to heaters of a plurality of battery modules.

### DETAILED DESCRIPTION

With reference to the drawings, like reference numerals designate identical or corresponding parts throughout the several views. However, the inclusion of like elements in different views does not mean a given embodiment necessarily includes such elements or that all embodiments of the invention include such elements.

The term “DC” refers to direct current and the term “AC” refers to alternating current. The terms “battery”, “battery module”, “battery power source”, and “energy storage element” are used interchangeably herein, are all energy storage devices, and may or may not include some form of a battery management system (BMS), in accordance with various embodiments. A battery module may include a plurality of electro-chemical cells (e.g., sodium-based electro-chemical cells) which need to be heated to a well regulated temperature range.

The term “component” as used herein can be defined as a portion of hardware, a portion of software, or a combination thereof. A portion of hardware can include at least a processor and a portion of memory, wherein the memory includes an instruction to execute. The term “circuit” as used herein refers to at least one component or combination of components (usually in reference to electrical components which may be programmable and/or non-programmable). The term “rectifier” or “rectifier circuit” as used herein refers to a circuit that converts an AC signal into a DC signal. The term “diode” as used herein refers to an electrical component that allows electrical current to flow in one direction.

“Software” or “computer program” as used herein includes, computer readable and/or executable instructions that cause a controller or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software may be dependent on, for example, requirements of a desired application, the environment it runs on, and/or the desires of a designer/programmer or the like.

“Computer” or “processing element” or “computer device” as used herein includes, but may be not limited to, any programmed or programmable electronic device that may store, retrieve, and process data. “Non-transitory computer-readable media” include, but may not be limited to, a CD-ROM, a removable flash memory card, a hard disk drive, a magnetic tape, and a floppy disk. “Computer memory”, as used herein, refers to a storage device configured to store digital data, information, or instructions which may be retrieved by a computer or processing element.

“Controller”, as used herein, refers to the logic circuitry and/or processing elements and associated software or program involved in managing battery modules. The terms “signal”, “data”, and “information” may be used interchangeably herein and may refer to digital or analog forms. The term “communication device” as used herein may refer to any wired or wireless device (e.g., a computer modem) operable to receive and/or transmit signals, data, or information. “Battery Management System” as used herein refers to a controller that is configured to control one or more battery modules in a battery back-up system.

The term “AC grid” as used herein refers to refers to the alternating current electrical network providing 3-phase electrical power. The term “DC bus” as used herein refers to the positive and negative rails that carry DC electrical power in a battery back-up system.

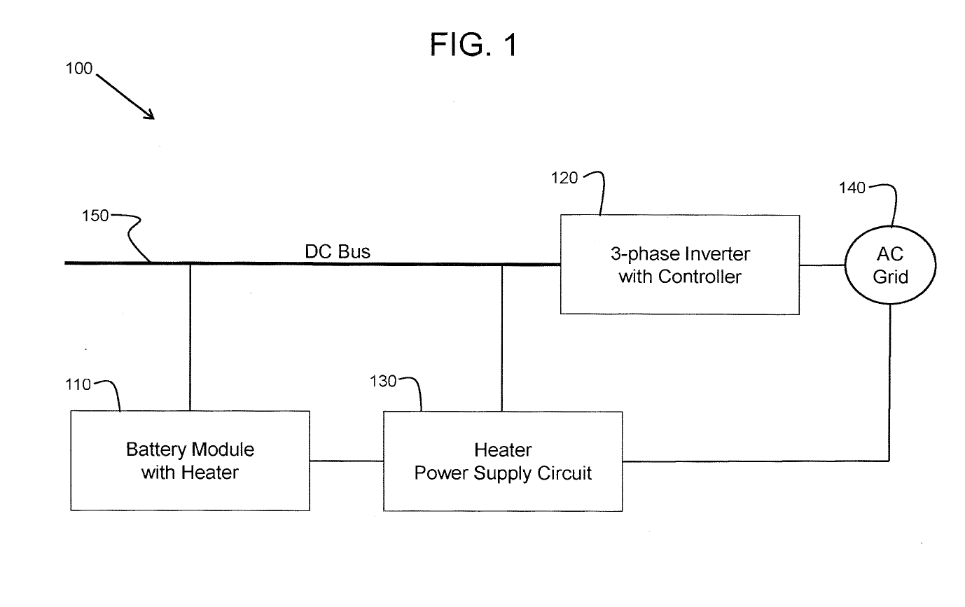

FIG. 1 is an illustration of a block diagram of an embodiment of a system 100 for providing power to a heater of a battery module 110. The system 100 includes a battery module 110 with a heater, a three-phase inverter with a controller 120, a heater power supply circuit 130, an alternating current (AC) grid 140, and a direct current (DC) bus 150. The AC grid 140 is operatively connected to the three-phase inverter with controller 120 and the heater power supply circuit 130. The DC bus 150 is operatively connected to the battery module with heater 110, the three-phase inverter with controller 120, and the heater power supply circuit 130.

In accordance with an embodiment, the battery module 110 includes electrochemical cells that have to be operated within a defined temperature range. The heater power supply circuit 130 provides DC electrical power to the heater within the battery module 110 to keep the electrochemical cells within the defined temperature range. The heater power supply circuit 130 may access electrical power from one of two sources including the AC grid 140 or the DC bus 150. Details of the conditions under which the heater power supply circuit 130 uses electrical power from the AC grid 140 or the DC bus 150 to provide DC power to the heater of the battery module 110 are described later herein.

In accordance with an embodiment, the battery module with heater 110 serves as a back-up source of DC power for a load that may be connected to the DC bus 150. For example, the load may be a set of telecommunications equipment at a cellular telephone cell tower site. During normal operation, the AC grid 140 provides electrical power for the load. The three-phase inverter with controller 120 converts the AC electrical power to DC electrical power and provides the DC electrical power to the DC bus to drive the load and/or to charge the battery module with heater 110. If the AC grid goes down and becomes unavailable, the battery module with heater 110 provides the DC electrical power to the DC bus to drive the load.

Furthermore, use of the AC grid 140 or the battery module with heater 110 to drive the load may be dependent on economic factors such as, for example, the cost of AC grid power at different times of day (e.g., peak usage times and non-peak usage times). Power from the AC grid 140 may be used to drive the load and charge the battery module 110 during non-peak times (when the cost of electricity from the AC grid is lower), and power from the battery module 110 may be used to drive the load during peak times (when the cost of electricity from the AC grid is higher).

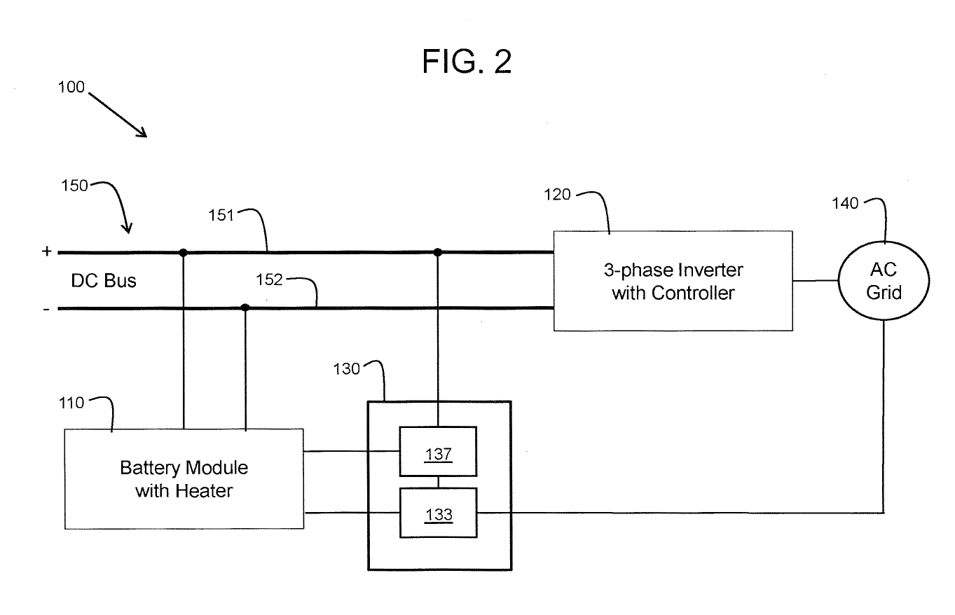

FIG. 2 is a more detailed illustration of a block diagram of the system 100 of FIG. 1. As shown in FIG. 2, the DC bus 150 includes a positive rail 151 and a negative rail 152. The battery module 110 is operatively connected to both the positive rail 151 and the negative rail 152. The heater power supply circuit 130 is operatively connected to the positive rail 151. Furthermore, the heater power supply circuit 130 includes a first circuit portion 133 operable to convert AC electrical power, provided by the AC grid 140, to a first DC electrical power. The heater power supply circuit also includes a second circuit portion 137 operable to output a second DC electrical power derived from the DC bus 150.

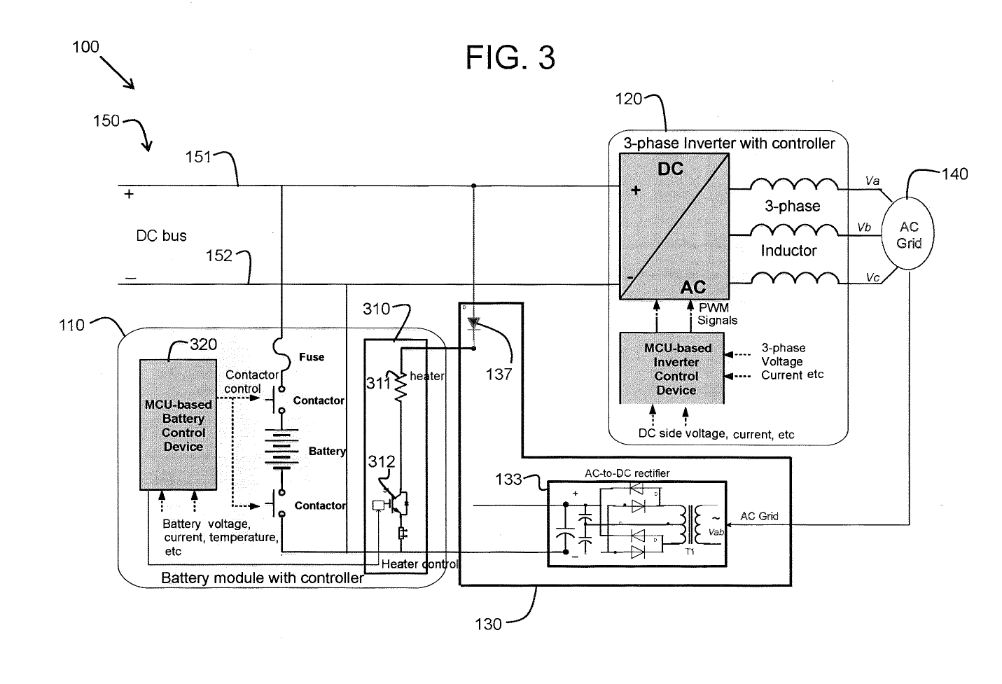

In accordance with an embodiment, the first circuit portion 133 and the second circuit portion 137 are operably connected and configured to provide either the first DC electrical power or the second DC electrical power to the heater circuit of the battery module 110 in dependence on a voltage level associated with the first circuit portion 133 relative to a voltage level associated with the second circuit portion 137, as is described in more detail with respect to FIG. 3.

FIG. 3 is an electrical schematic illustration of the system 100 of FIG. 1 and FIG. 2. FIG. 3 shows a heater 310 within the battery module 110. The heater 310 includes a resistive element 311 and a transistor switch 312 which is controlled by a controller 320 to turn the heater on and off (e.g., via pulse width modulation). As seen in FIG. 3, the first circuit portion 133 of the heater power supply circuit 130 is an AC-to-DC rectifier that converts AC electrical power from the AC grid 140 to DC electrical power. The second circuit portion 137 of the heater power supply circuit 130 is a diode connected to the positive rail 151 of the DC bus 150. The AC-to-DC rectifier 133 and the diode 137 are connected to each other and are also connected to the heater 310 to provide electrical power to the heater 310.

When the DC voltage level output by the AC-to-DC rectifier 133 is higher than the DC voltage level at the input (anode) of the diode 137 (as established by the voltage level on the positive rail 151), the diode 137 is reverse biased and, therefore, electrical current to the heater 310 is provided from the AC grid 140 via the AC-to-DC rectifier 133. When the DC voltage level output by the AC-to-DC rectifier 133 is lower than the DC voltage level at the input (anode) of the diode 137 (as established by the voltage level on the positive rail 151), the diode 137 is forward biased and, therefore, electrical current to the heater 310 is provided from the DC bus 150 via the diode 137. The DC bus 150 may be energized by the battery module 110 or by some other DC source connected to the DC bus 150.

In this manner, if the AC grid 140 is providing power to the heater 310 and then goes down (becomes unavailable), the heater power supply circuit 130 will automatically transition to supply power to the heater 310 from the DC bus 150 via the diode 137. The transition is automatic and seamless. In accordance with an embodiment, the first circuit portion 133 and the second circuit portion 137 of the heater power supply circuit 130 are non-programmable, analog circuit portions. No separate control circuitry, controller, or software control scheme is used to make the transition.

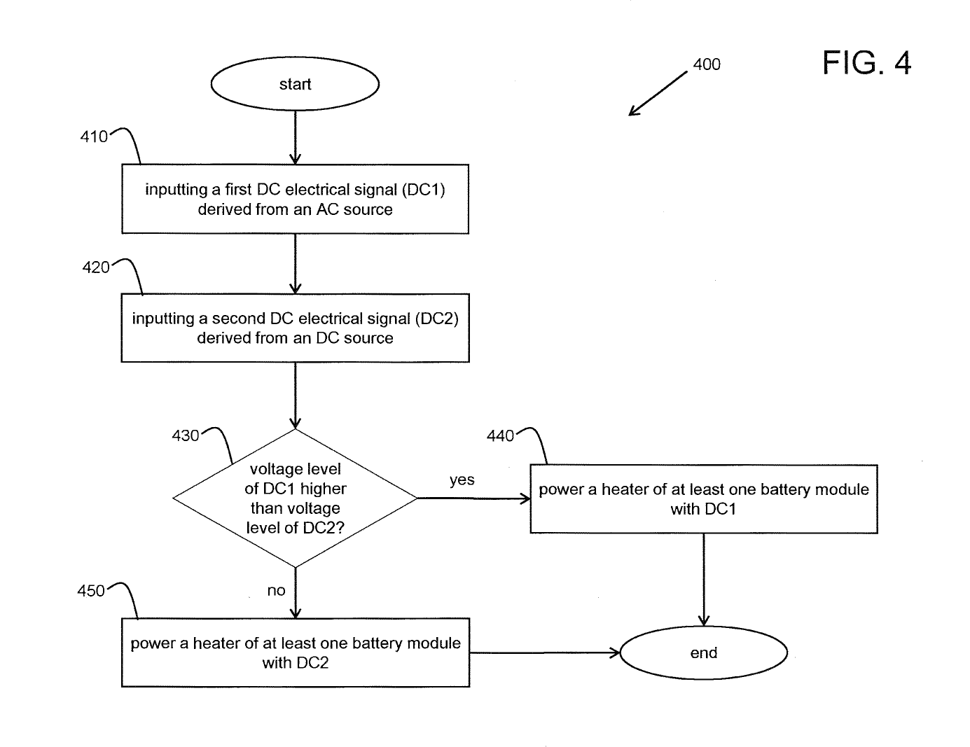

FIG. 4 is a flowchart of an embodiment of a method 400 to provide power to a heater of at least one battery module. In step 410 of the method, a first DC electrical signal (DC1) derived from an AC source is input. For example, DC1 may be derived from the AC grid 140 by the AC-to-DC rectifier 133. In step 420, a second DC electrical signal (DC2) derived from a DC source is input. For example, DC2 may be derived from the DC bus 150 by the diode 137. In step 430, if the voltage level of DC1 (e.g., at the output of the rectifier 133) is higher than the voltage level of DC2 (e.g., at the input of the diode 137) then, in step 440, a heater of at least one battery module is powered with DC1 derived from the AC source (e.g., because the diode 137 is reversed biased). Otherwise, a heater of at least one battery module is powered with DC2 derived from the DC source (e.g., because the diode 137 is forward biased).

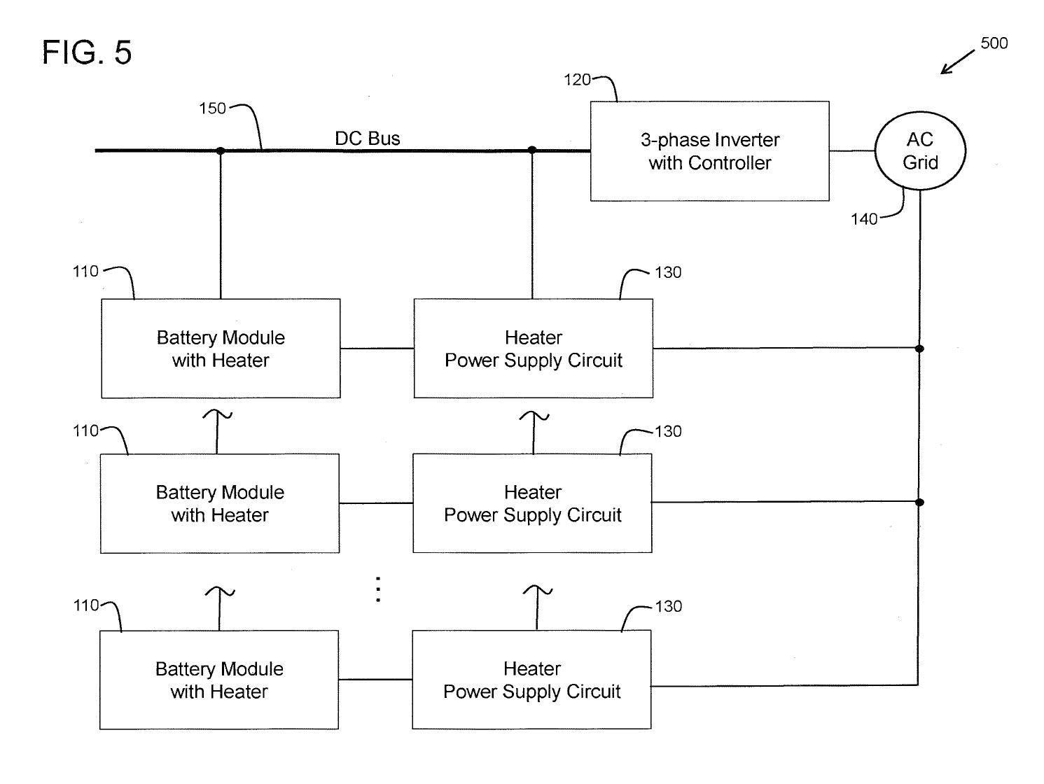

Many battery back-up systems use a plurality of battery modules to provide DC power to a load connected to a DC bus during peak times or when the AC grid (or some other AC source) is not available. Having more than one battery module provides redundancy and/or provides additional DC electrical power to drive one or more loads. FIGS. 5-16 illustrate various embodiments of systems providing a plurality of battery modules that are heated using the techniques described herein.

FIG. 5 is an illustration of a block diagram of a first embodiment of a system 500 providing power to a heater of each of a plurality of battery modules 110. Each battery module 110 is associated with and operatively connected to a dedicated heater power supply circuit 130, and is operatively connected to the DC bus 150. Each heater power supply circuit 130 is operatively connected to the AC grid 140 and the DC bus 150. The system 500 of FIG. 5 allows for the use of multiple pairs of battery modules 110 and heater power supply circuits 130.

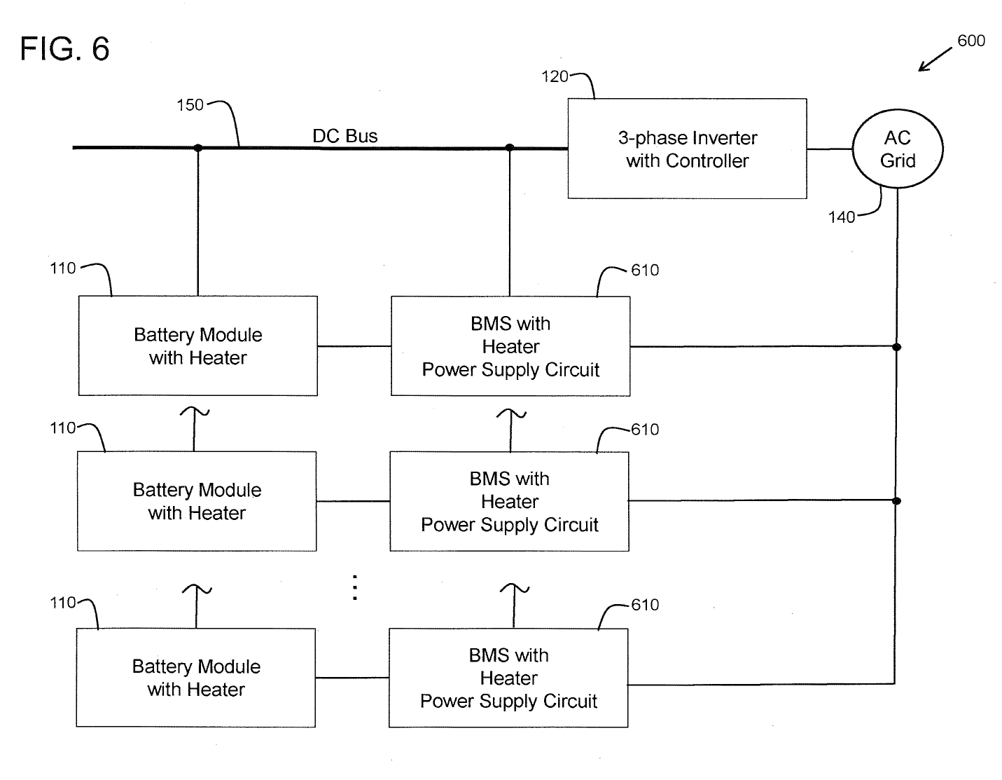

FIG. 6 is an illustration of a block diagram of a second embodiment of a system 600 providing power to a heater of each of a plurality of battery modules 110. Each battery module 110 is associated with and operatively connected to a dedicated battery management system (BMS) 610 having a heater power supply circuit 130, and is operatively connected to the DC bus 150. That is, a heater power supply circuit 130 is integrated into each of the BMS's 610. Each BMS 610 with heater power supply circuit 130 is operatively connected to the AC grid 140 and the DC bus 150. The system 600 of FIG. 6 allows for each battery module 110 to be controlled by a separate BMS 610.

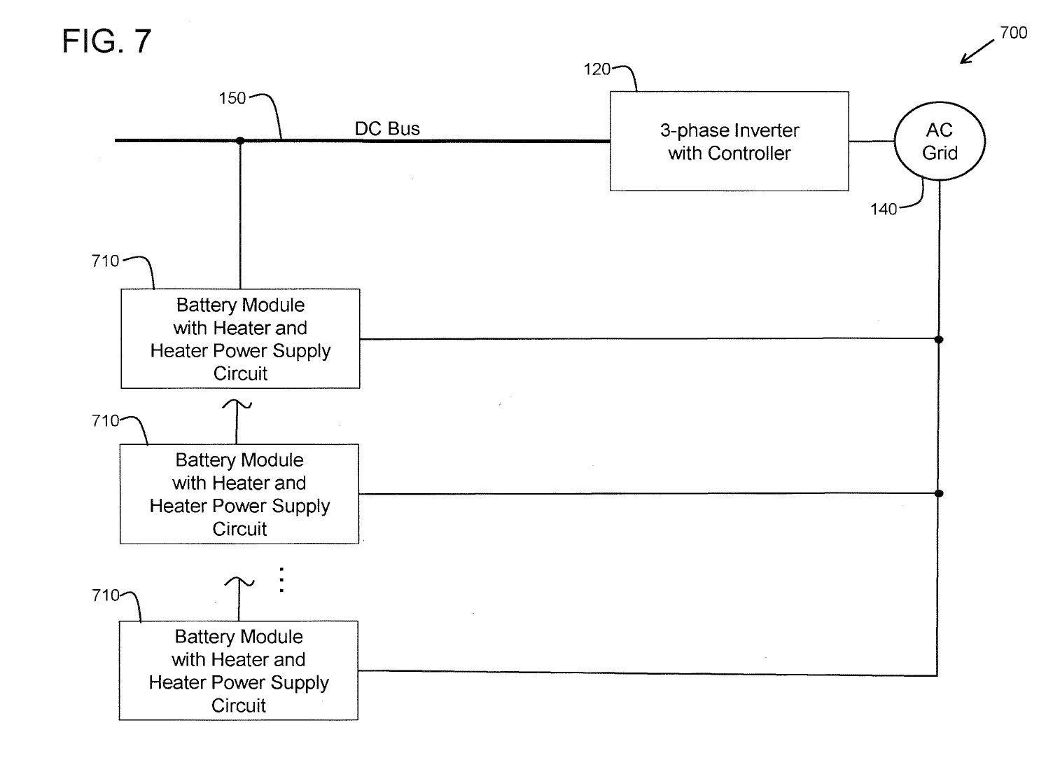

FIG. 7 is an illustration of a block diagram of a third embodiment of a system 700 providing power to a heater of each of a plurality of battery modules 710. Each battery module 710 includes an integrated heater power supply circuit 130 configured to provide electrical power to a heater within the battery module. Each battery module 710 is operatively connected to the AC grid 140 and the DC bus 150. The system 700 of FIG. 7 may save space and eliminate additional interconnects by integrating a heater power supply circuit 130 into each battery module 710.

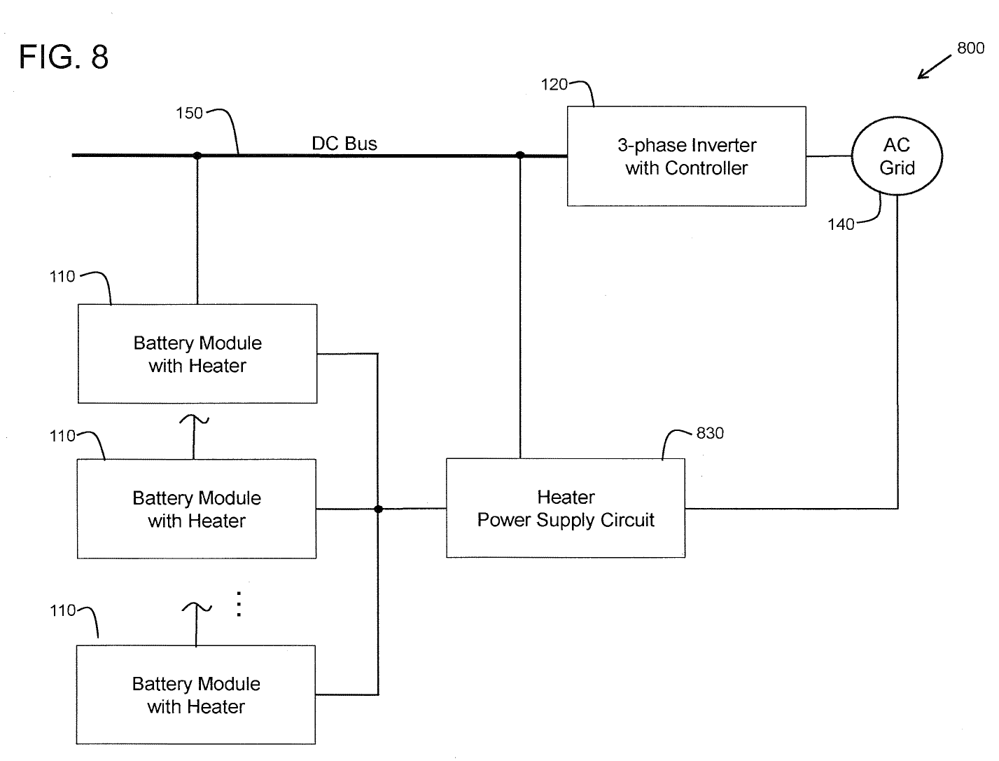

FIG. 8 is an illustration of a block diagram of a fourth embodiment of a system 800 providing power to a heater of each of a plurality of battery modules 110. The heaters of each of the battery modules 110 are driven by the same single heater power supply circuit 830. The single heater power supply circuit 830 is configured to be able to provide enough current for the heaters of all of the battery modules 110, simultaneously. For example, the single heater power supply circuit 830 may be very similar to the heater power supply circuit 130 but may have electrical components capable of handling higher current levels. The single heater power supply circuit 830 is operatively connected to the AC grid 140 and the DC bus 150. Each of the battery modules 110 are operatively connected to the DC bus and the single heater power supply circuit 830. The system 800 of FIG. 8 allows for a single heater power supply circuit 830 to accommodate more than one battery module 110.

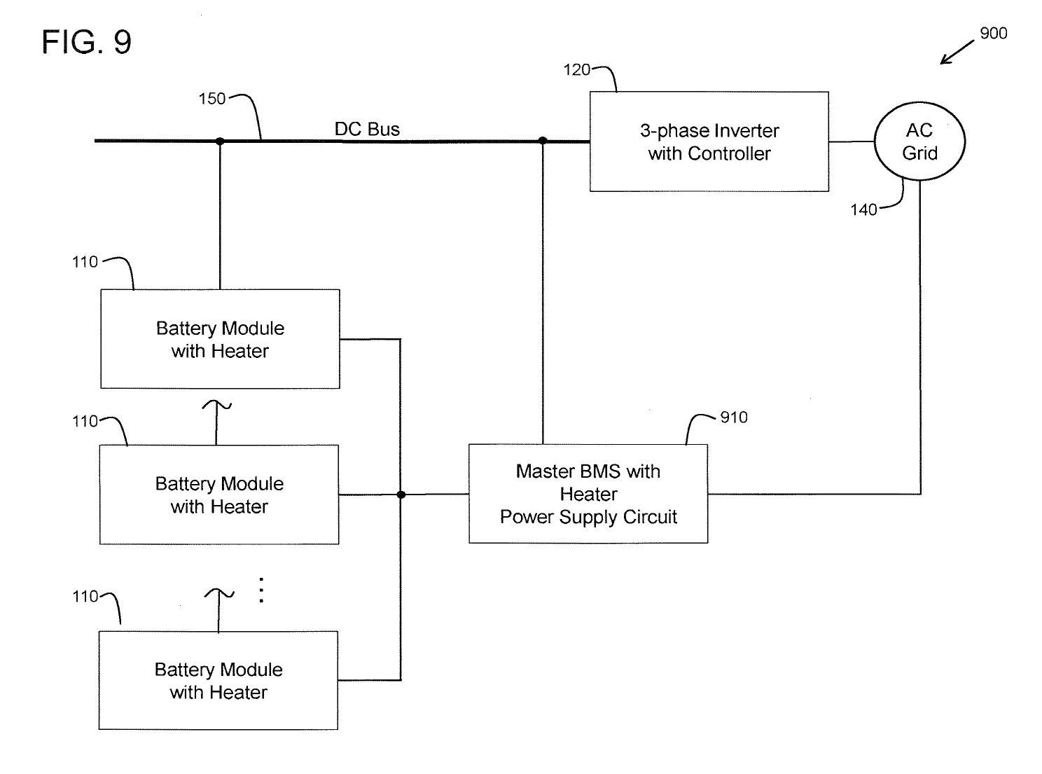

FIG. 9 is an illustration of a block diagram of a fifth embodiment of a system 900 providing power to a heater of each of a plurality of battery modules 110. The heaters of each of the battery modules 110 are driven by the same single heater power supply circuit which is integrated into a master BMS 910. The single heater power supply circuit within the master BMS 910 is configured to be able to provide enough current for the heaters of all of the battery modules 110, simultaneously. For example, the single heater power supply circuit of the master BMS 910 may be very similar to the heater power supply circuit 130 but may have electrical components capable of handling higher current levels. The master BMS 910 is operatively connected to the AC grid 140 and the DC bus 150. Each of the battery modules 110 are operatively connected to the DC bus and the master BMS 910. The system 900 of FIG. 9 allows for a master BMS 910 to accommodate more than one battery module 110.

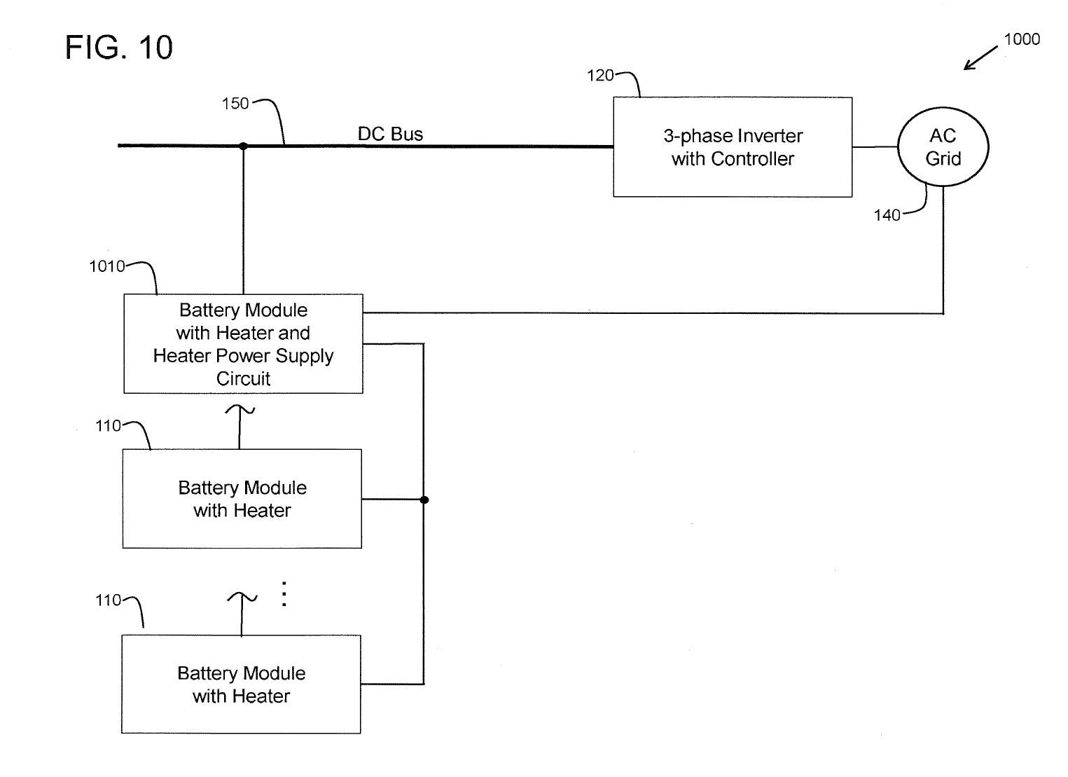

FIG. 10 is an illustration of a block diagram of a sixth embodiment of a system 1000 providing power to a heater of each of a plurality of battery modules 1010 and 110. A first battery module 1010 of the plurality of battery modules includes a single heater power supply circuit. The other battery modules 110 of the plurality of battery modules do not include a heater power supply circuit. The single heater power supply circuit of battery module 1010 drives the heater of not only battery module 1010 but also the heaters of the other battery modules 110. For example, the single heater power supply circuit of battery module 1010 may be very similar to the heater power supply circuit 130 but may have electrical components capable of handling higher current levels to drive the heaters of additional battery modules 110. The system 1000 of FIG. 10 allows for one unique battery module 1010 to accommodate multiple common battery modules 110.

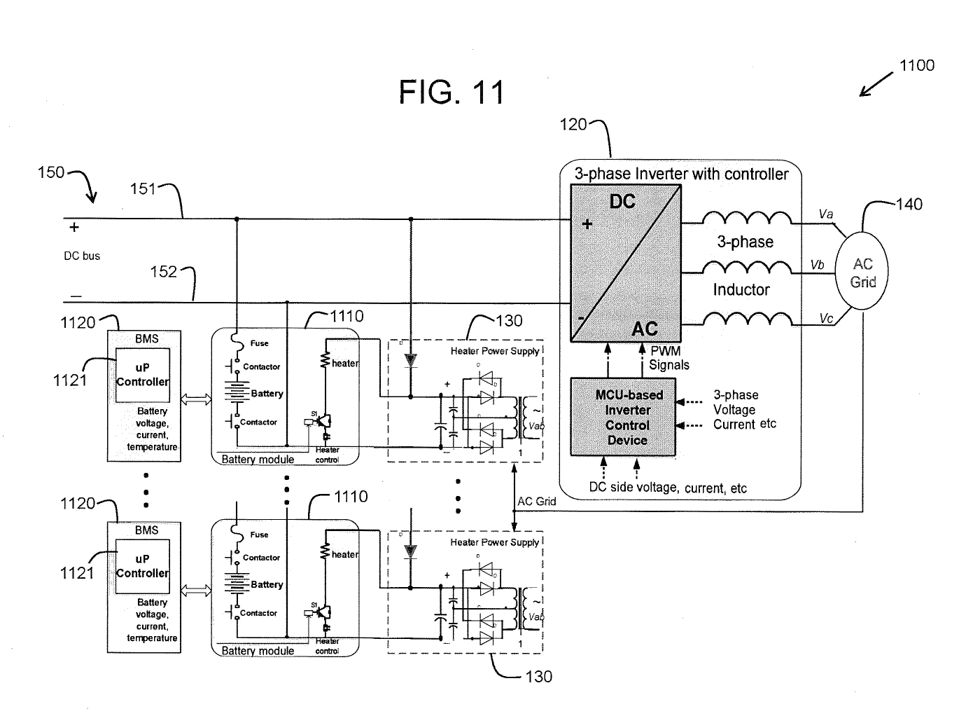

FIG. 11 is an electrical schematic illustration of an embodiment of a system 1100 for providing power to heaters of a plurality of battery modules 1110. The battery modules 1110 are similar to the battery modules 110 herein except that the battery modules 1110 do not include a controller for controlling the heater of a battery module. A dedicated heater power supply circuit 130 and a dedicated BMS 1120 is provided for each battery module 1110. Each dedicated BMS 1120 includes a controller 1121 for controlling the heater of each corresponding battery module 1110 (i.e., to control the turning on and turning off of the heater).

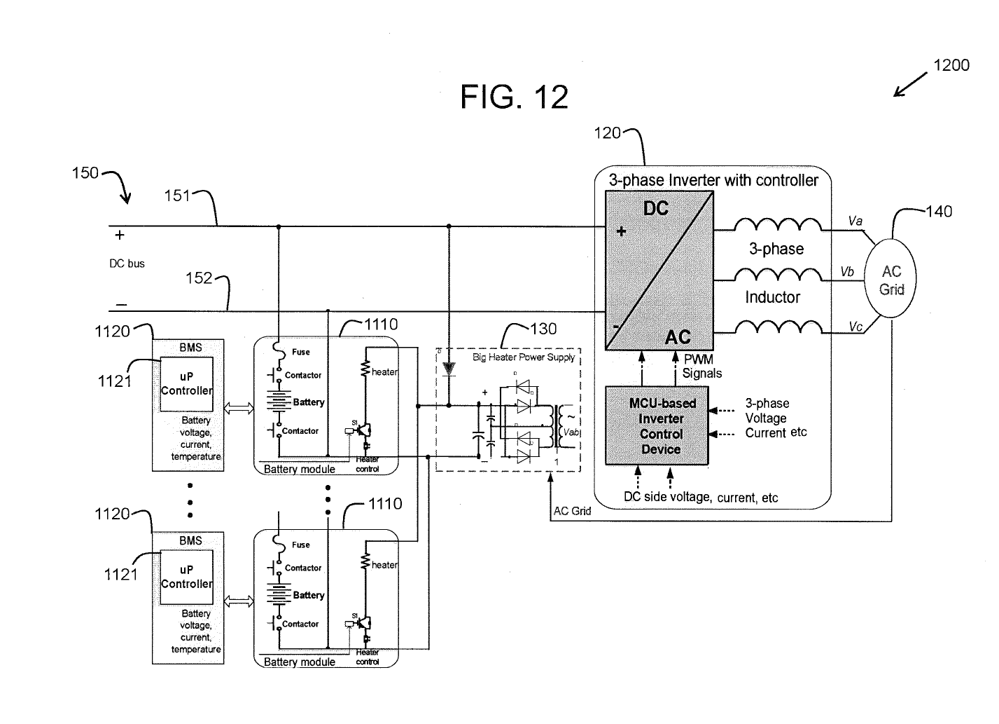

FIG. 12 is an electrical schematic illustration of a first alternate embodiment of a system 1200 for providing power to heaters of a plurality of battery modules 1110. A dedicated BMS 1120 is provided for each battery module 1110 and a single common battery heater power supply circuit 130 is provided to drive the heaters of all the battery modules 1110. Again, each dedicated BMS 1120 includes a controller 1121 for controlling the heater of each corresponding battery module 1110.

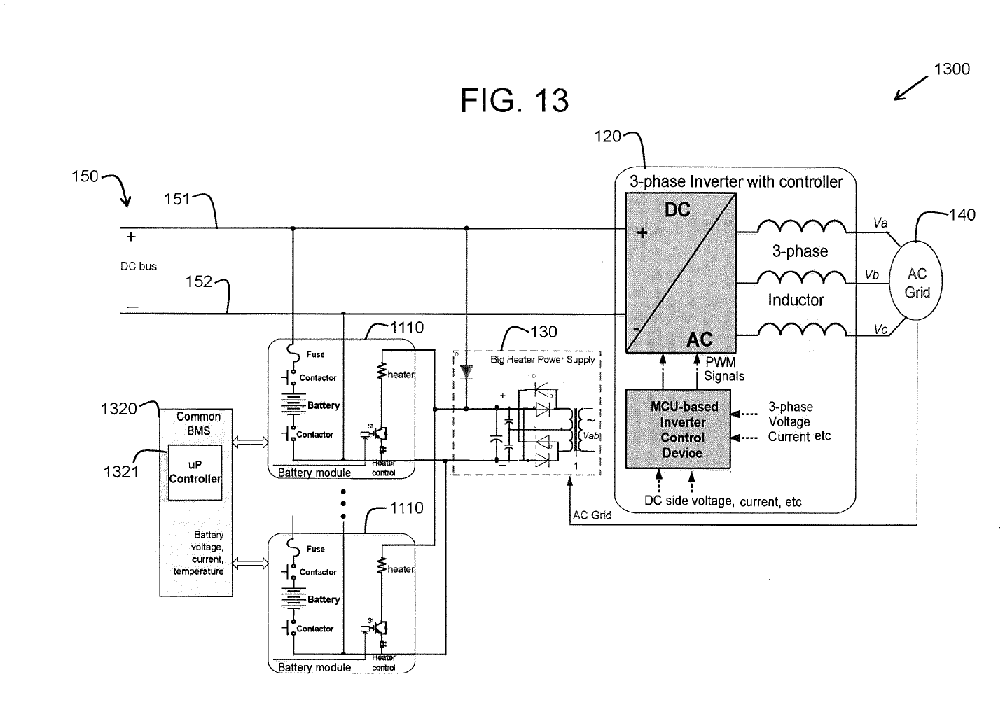

FIG. 13 is an electrical schematic illustration of a second alternate embodiment of a system 1300 for providing power to heaters of a plurality of battery modules. A single common BMS 1320 is provided to control all of the battery modules 1110, and a single common heater power supply circuit 130 is provided to drive the heaters of all the battery modules 1110. The single common BMS 1320 includes a common controller 1321 for controlling the heaters of all the battery modules 1110.

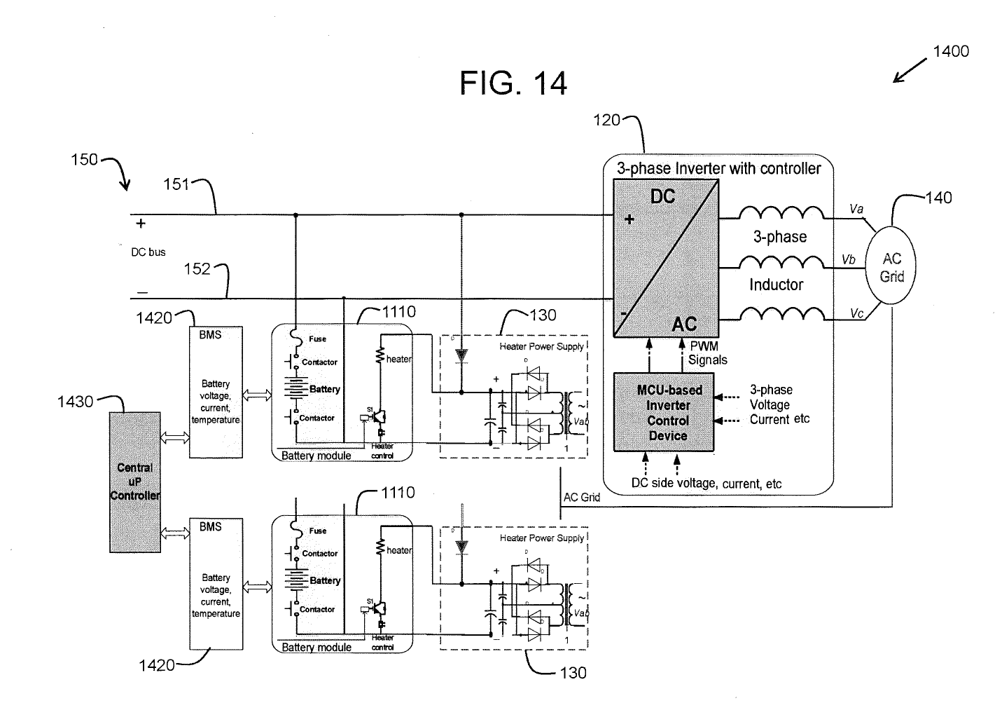

FIG. 14 is an electrical schematic illustration of a third alternate embodiment of a system 1400 for providing power to heaters of a plurality of battery modules 1110. A dedicated heater power supply circuit 130 is provided for each battery module 1110, and a dedicated BMS 1420 is provided for each battery module 1110. Furthermore, a common master controller 1430 for controlling the heater of each battery module 1110 via a corresponding BMS 1420 is provided, instead of having a controller for controlling the heaters in each BMS.

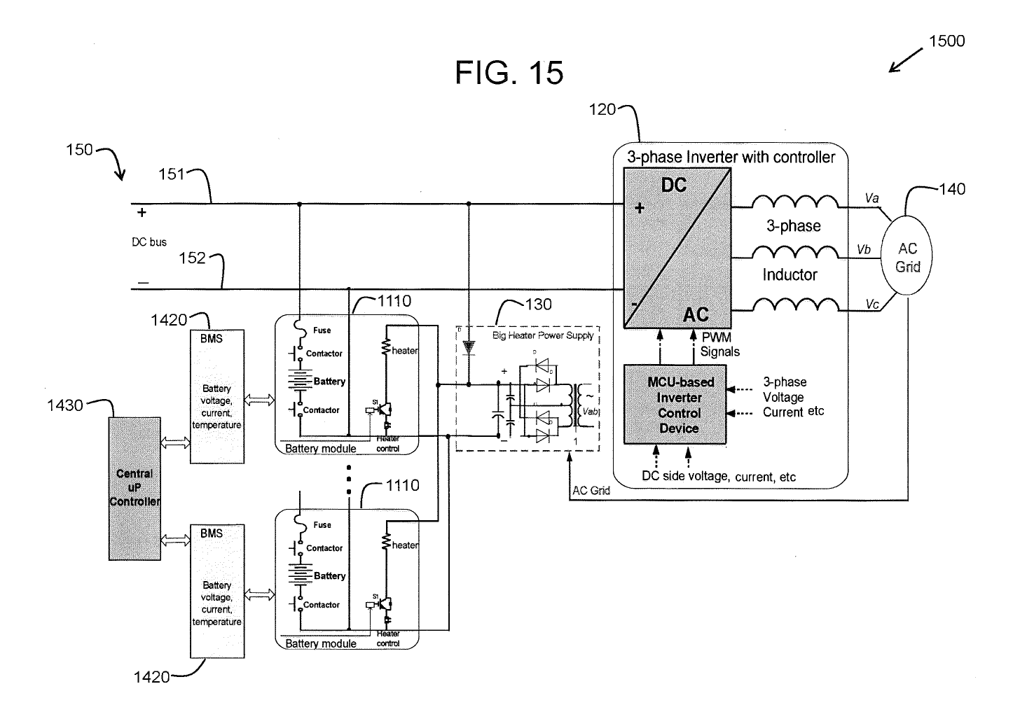

FIG. 15 is an electrical schematic illustration of a fourth alternate embodiment of a system 1500 for providing power to heaters of a plurality of battery modules 1110. A single common heater power supply circuit 130 is provided to drive the heaters of all the battery modules 1110, and a dedicated BMS 1420 is provided for each battery module 1110. Furthermore, a common master controller 1430 for controlling the heater of each battery module 1110 via a corresponding BMS 1420 is provided.

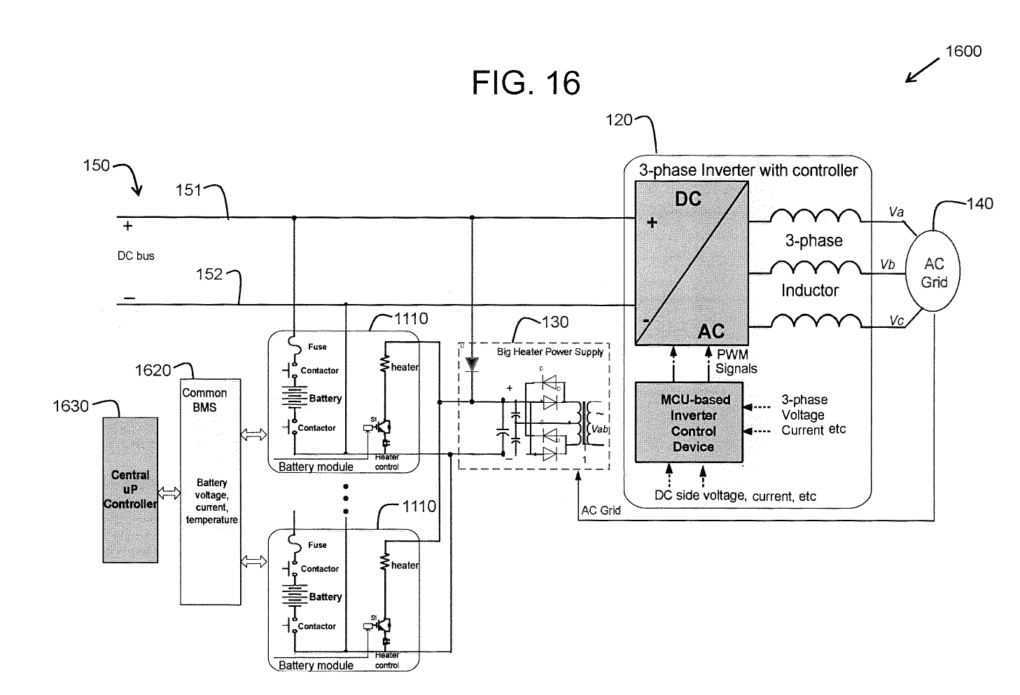

FIG. 16 is an electrical schematic illustration of a fifth alternate embodiment of a system 1600 for providing power to heaters of a plurality of battery modules 1110. A single common heater power supply circuit 130 is provided to drive the heaters of all the battery modules 1110, and a single common BMS 1620 is provided to control all the battery modules 1110. Furthermore, a common master controller 1630 for controlling the heater of each battery module 1110 via the common BMS 1520 is provided.

In one embodiment, a power supply circuit is provided that is a combined AC/DC heater power supply circuit configured to provide a complete and real solution to the heater start-up issue as well as the AC grid outage problem. The power supply circuit includes a first circuit portion operable to convert AC electrical power, provided by an AC source, to a first DC electrical power. The power supply circuit also includes a second circuit portion operable to output a second DC electrical power derived from a DC bus operably connected to at least one DC source. The first circuit portion and the second circuit portion are operably connected and configured to provide either the first DC electrical power or the second DC electrical power to a heater circuit of a battery module in dependence on a voltage level associated with the first circuit portion relative to a voltage level associated with the second circuit portion. The first DC electrical power may be provided to the heater circuit when the voltage level associated with the first circuit portion is higher than the voltage level associated with the second circuit portion. The second DC electrical power may be provided to the heater circuit when the voltage level associated with the first circuit portion is lower than the voltage level associated with the second circuit portion. The first circuit portion may include a rectifier circuit and the second circuit portion may include a diode. In accordance with an embodiment, the first circuit portion and the second circuit portion are configured to provide either the first DC electrical power or the second DC electrical power to drive the heater circuit in a battery module in dependence on a DC voltage level output by the first circuit portion relative to a DC voltage level of the DC bus. The power supply circuit may not employ executable software instructions to provide either the first DC electrical power or the second DC electrical power to the heater circuit of a battery module in dependence on a voltage level associated with the first circuit portion relative to a voltage level associated with the second circuit portion. Instead, the first circuit portion and the second circuit portion may be non-programmable, analog circuit portions.

In one embodiment, a system is provided for supplying power to heat a plurality of battery modules. The system includes a plurality of battery modules and a plurality of the power supply circuits described above herein. Each battery module of the plurality of battery modules is associated with one power supply circuit of the plurality of power supply circuits. Each power supply circuit of the plurality of power supply circuits is configured to provide either the first DC electrical power or the second DC electrical power to a heater circuit in an associated battery module in dependence on a voltage level associated with the first circuit portion of the power supply circuit relative to a voltage level associated with the second circuit portion of the power supply circuit. The system may also include a plurality of battery management systems, where each battery module of the plurality of battery modules is associated with one battery management system of the plurality of battery management systems, and where each battery management system of the plurality of battery management systems includes one power supply circuit of the plurality of power supply circuits. Alternatively, each battery module of the plurality of battery modules may include an associated power supply circuit of the plurality of power supply circuits. In accordance with various embodiments, the plurality of power supply circuits may be external to the plurality of battery modules.

In one embodiment, a system is provided for supplying power to heat a plurality of battery modules. The system includes a plurality of battery modules and at least one heater power supply circuit as described above herein and configured to provide either the first DC electrical power or the second DC electrical power to a heater circuit of each of the plurality of battery modules in dependence on a voltage level associated with the first circuit portion of the at least one power supply circuit relative to a voltage level associated with the second circuit portion of the at least one power supply circuit. The system may also include a master controller configured to control the plurality of battery modules, wherein the master controller includes the at least one power supply circuit. In accordance with an embodiment, the at least one power supply circuit is external to the plurality of battery modules. In accordance with another embodiment, the at least one power supply circuit is internal to at least one battery module of the plurality of battery modules.

In one embodiment, a method is provided for powering at least one battery module. The method includes inputting a first DC electrical signal derived from an AC source, inputting a second DC electrical signal derived from a DC source, and powering a heater of at least one battery module with either the first DC electrical signal or the second DC electrical signal in dependence on a DC voltage level of the first DC electrical signal relative to a DC voltage level of the second DC electrical signal. The first DC electrical signal may be used to power the heater when the DC voltage level of the first DC electrical signal is higher than the DC voltage level of the second DC electrical signal. The second DC electrical signal may be used to power the heater when the DC voltage level of the first DC electrical signal is lower than the DC voltage level of the second DC electrical signal. The first DC electrical signal may be derived from the AC source by an AC-to-DC rectifier circuit operatively connected to the AC source, and the second DC electrical signal may be derived from the DC source by a diode operatively connected to the DC source, in accordance with an embodiment. The AC source may include an AC grid and the DC source may include a DC bus.

In summary, systems and methods for supplying power to a battery heater in one or more battery modules are disclosed. A first DC electrical signal derived from an AC source or a second DC electrical signal derived from a DC bus is used to power a battery heater of one or more battery modules in dependence on a voltage level associated with the first DC electrical signal relative to a voltage level of the second DC electrical signal.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A power supply circuit, comprising:
a first circuit portion operable to convert AC electrical power, provided by an AC source, to a first DC electrical power; and
a second circuit portion operable to output a second DC electrical power derived from a DC bus operably connected to at least one DC source,
wherein the first circuit portion and the second circuit portion are operably connected and configured to provide either the first DC electrical power or the second DC electrical power to a heater circuit of a battery module in dependence on a voltage level associated with the first circuit portion relative to a voltage level associated with the second circuit portion.

2. The power supply circuit according to claim 1, wherein the first circuit portion and the second circuit portion are configured to provide the first DC electrical power to the heater circuit when the voltage level associated with the first circuit portion is higher than the voltage level associated with the second circuit portion.

3. The power supply circuit according to claim 1, wherein the first circuit portion and the second circuit portion are configured to provide the second DC electrical power to the heater circuit when the voltage level associated with the first circuit portion is lower than the voltage level associated with the second circuit portion.

4. The power supply circuit according to claim 1, wherein the first circuit portion includes a rectifier circuit and the second circuit portion includes a diode.

5. The power supply circuit according to claim 1, wherein the first circuit portion and the second circuit portion are configured to provide either the first DC electrical power or the second DC electrical power to drive the heater circuit in the battery module in dependence on a DC voltage level output by the first circuit portion relative to a DC voltage level of the DC bus.

6. The power supply circuit according to claim 1, wherein the power supply circuit does not employ executable software instructions to provide either the first DC electrical power or the second DC electrical power to the heater circuit of the battery module in dependence on the voltage level associated with the first circuit portion relative to the voltage level associated with the second circuit portion.

7. The power supply circuit according to claim 1, wherein the first circuit portion and the second circuit portion are non-programmable, analog circuit portions.

8. A system comprising:
a plurality of battery modules; and
a plurality of the power supply circuits of claim 1, where each battery module of the plurality of battery modules is associated with one power supply circuit of the plurality of power supply circuits, and where each power supply circuit of the plurality of power supply circuits is configured to provide either the first DC electrical power or the second DC electrical power to a heater circuit in an associated battery module in dependence on a voltage level associated with the first circuit portion of the power supply circuit relative to a voltage level associated with the second circuit portion of the power supply circuit.

9. The system according to claim 8, further comprising a plurality of battery management systems, where each battery module of the plurality of battery modules is associated with one battery management system of the plurality of battery management systems, and where each battery management system of the plurality of battery management systems includes one power supply circuit of the plurality of power supply circuits.

10. The system according to claim 8, wherein each battery module of the plurality of battery modules includes an associated power supply circuit of the plurality of power supply circuits.

11. The system according to claim 8, wherein the plurality of power supply circuits are external to the plurality of battery modules.

12. A system comprising:
a plurality of battery modules; and
at least one power supply circuit of claim 1, where the at least one power supply circuit is configured to provide either the first DC electrical power or the second DC electrical power to a heater circuit of each of the plurality of battery modules in dependence on a voltage level associated with the first circuit portion of the at least one power supply circuit relative to a voltage level associated with the second circuit portion of the at least one power supply circuit.

13. The system according to claim 12, further comprising a master controller configured to control the plurality of battery modules, wherein the master controller includes the at least one power supply circuit.

14. The system according to claim 12, wherein the at least one power supply circuit is external to the plurality of battery modules.

15. The system according to claim 12, wherein the at least one power supply circuit is internal to at least one battery module of the plurality of battery modules.

16. A method comprising:
inputting a first DC electrical signal derived from an AC source;
inputting a second DC electrical signal derived from a DC source; and
powering a heater of at least one battery module with either the first DC electrical signal or the second DC electrical signal in dependence on a DC voltage level of the first DC electrical signal relative to a DC voltage level of the second DC electrical signal.

17. The method according to claim 16, wherein the first DC electrical signal is used to power the heater when the DC voltage level of the first DC electrical signal is higher than the DC voltage level of the second DC electrical signal.

18. The method according to claim 16, wherein the second DC electrical signal is used to power the heater when the DC voltage level of the first DC electrical signal is lower than the DC voltage level of the second DC electrical signal.

19. The method according to claim 16, wherein the first DC electrical signal is derived from the AC source by an AC-to-DC rectifier circuit operatively connected to the AC source, and wherein the second DC electrical signal is derived from the DC source by a diode operatively connected to the DC source.

20. The method according to claim 16, wherein the AC source includes an AC grid, and wherein the DC source includes a DC bus.
